(19) United States
(12) Patent Application Publication
(10) Pub. No.: US 2012/0077634 A1
(43) Pub. Date: Mar. 29, 2012

(54) FULLY-GEARED CONTINUOUSLY VARIABLE TRANSMISSION

(76) Inventor: Harry Thompson, Rockledge, FL (US)

(21) Appl. No.: 13/245,724

(22) Filed: Sep. 26, 2011

Related U.S. Application Data
(60) Provisional application No. 61/387,977, filed on Sep. 29, 2010.

(51) Int. Cl. F16H 59/00; F16H 3/44

(52) U.S. Cl. 475/116; 475/269; 475/311; 475/317; 475/323; 475/154; 475/207

(57) ABSTRACT

A continuously variable transmission (CVT) responsive to a device for supplying a rotational force. The transmission comprises a planetary gear system that further comprises: a control element, an output element, and an input element caused to rotate responsive to the device for supplying rotational force. The output element is engaged with the control element and the input element. The CVT further comprises a control module comprising a controllable brake connected to the control element for allowing the control element to rotate freely, for stopping the control element and for slowing the control element to a speed between free rotation and stopped.

### CROSS REFERENCE TO RELATED APPLICATIONS

This patent application claims the benefit of the provisional patent application No. 61/387,977 filed on Sep. 29, 2010 and entitled A Fully-Geared Continuously Variable Transmission.

### FIELD OF THE INVENTION

The present invention relates to vehicle transmissions and more particularly to continuously variable vehicle transmissions.

### BACKGROUND OF THE INVENTION

Numerous continuously variable transmission devices exist, but they depend upon an underlying principal of rotating devices connected through friction to provide a variable ratio or use a fluid as the primary force transmission agent with variable pumps and motors. Variable input/output ratios have also been achieved using “V” belts and variable diameter pulley hubs that change the input/output ratios. These CVT (continuously variable transmission) devices exist in a number of current automobiles such as the Audi and Nissan Versa and also in many all-terrain vehicles. The width (depth of the V-groove) of each pulley is varied inversely with the width of the mating pulley. This technique effectively changes the operating diameter of each pulley's hub and thereby provides a continuously variable gear ratio.

Opposing conical devices with a connecting moveable belt have achieved similar results as have variable ratio devices using rotating toroidal surfaces. These devices all rely upon friction to achieve the variable input/output ratios and are limited in the amount of horsepower and/or torque that can be reliably handled by such transmission devices. They also all suffer from low reliability and relatively short lifetimes due to the excessive friction upon which each relies.

Other designs rely upon variable hydraulic or fluid pump/motor devices to achieve the basic function of varying the input-to-output power transmission ratios characteristic of a CVT. These devices tend to generate significant fluidic heat and are therefore useful only in slow speed applications such as earth moving equipment and mining applications. Uniquely, the 1950 Buick employed such an automatic transmission, known commercially as a Dynaflo® transmission.

One prior art CVT system is described in patent application publication number 2009/0227413. The present invention represents a significant improvement over the CVT implementation described in that patent application publication, which requires control of one or more hydraulic valves on a freely rotating surface. This feature requires a complicated control scheme and requires significant additional machinery to implement neutral and reverse gears.

A conventional planetary gear system 10 is illustrated in FIGS. 1 (front view) and 2 (side view). The planetary gear system 10 comprises three elements; a ring gear 12, a sun gear 14, planetary gears 16 and an attendant planetary carrier 18. One of these gear elements is designated as the “input” element, one as the “output” element, and the remaining element is fixed.

In FIGS. 1 and 2, the sun gear 14 serves as the input, i.e., connected to an input shaft 19, and rotates responsive to a rotational force producing device (not shown) imparting rotation to the input shaft 19 (and therefore to the sun gear 14) as indicated by an arrowhead 20. The ring gear 12 is fixed and the planetary carrier 18 operates as the output element.

Rotation of the sun gear 14 in the direction of the arrowhead 20 causes the planetary gears 16 to rotate in a direction indicated by an arrowhead 23 in FIG. 1. Rotation of the planetary gears 16 meshing with the fixed ring gear 12 causes the planetary carrier 18 to rotate in a direction indicated by an arrowhead 25. Since the planetary carrier 18 is connected to an output shaft 27, the shaft 27 rotates as indicated by the arrowhead 25. Thus rotational forces applied to the input sun gear 14 (such as by an engine or motor) are transmitted to the output planetary carrier 18 when the ring gear 12 is fixed, i.e., cannot rotate.

The output speed of the planetary carrier 18 (the output shaft 27) is determined by a number of teeth in the sun gear and ring gear. A gear combination with any number of teeth can be used. The number of teeth merely produces a different “full” or “natural” output speed.

There is a need for an efficient, reliable transmission that can replace existing designs to improve fuel efficiency by continuously varying the gear ratio, permitting the engine to operate at peak efficiency, while providing a variable gear ratio to the driven wheels. There is also a need for more efficient transmission of motive power for applications such as bicycles and motorcycles. The present invention provides an elegantly simple solution to these requirements.

### BRIEF DESCRIPTION OF THE DRAWINGS

The present invention can be more easily understood and the further advantages and uses thereof more readily apparent, when considered in view of the following detailed description when read in conjunction with the following figures, wherein:

FIGS. 1 and 2 illustrate respective front and side views of a prior art planetary gear system.

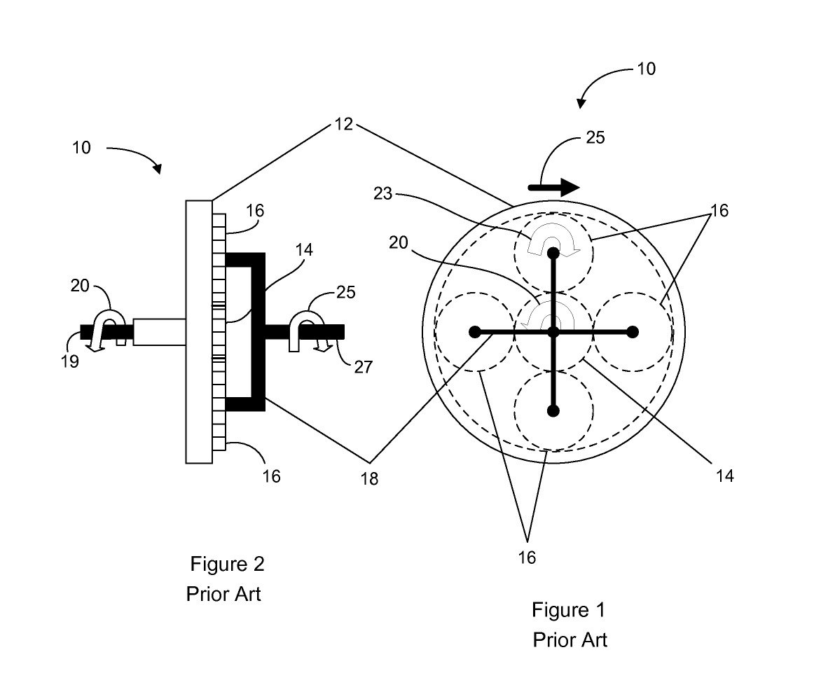

FIGS. 3 and 4 illustrate first and second embodiments of a CVT according to the teachings of the present invention.

FIG. 5 illustrates an embodiment of a CVT control module according to the teachings of the present invention.

In accordance with common practice, the various described features are not drawn to scale, but are drawn to emphasize specific features relevant to the invention. Reference characters denote like elements throughout the figures and text.

### DETAILED DESCRIPTION OF THE INVENTION

Before describing in detail the particular methods and apparatuses related to embodiments of a continuously variable transmission, it should be observed that the present invention resides primarily in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the inventions.

The presented embodiments are not intended to define limits as to the structures, elements or methods of the invention, but only to provide exemplary constructions. The embodiments are permissive rather than mandatory and illustrative rather than exhaustive.

Broadly, the presented embodiments teach a continuously variable transmission that provides an infinitely (or nearly infinite) variable rotational ratio between an input rotating shaft and an output rotating shaft.

The embodiments implement a continuously variable transmission through a unique and elegantly simple application of the well-known and much-used planetary gear system. Such planetary gear systems are used in almost all current automotive, multi-speed, automatic transmissions for rotational speed reduction and gear selection.

Any mechanical engineering handbook defines a planetary gear system as a combination of three major components: a ring gear, a sun gear, and planetary gears and the planetary gears carrier. It is also conventional wisdom that at least one of the gear elements must be fixed to transmit torque between an input and an output shaft.

However, the inventor of the present invention has determined that by controlling rotation of the “fixed” element the planetary gear system can achieve an infinitely variable ratio between the planetary gear system input and output elements. Thus the presented embodiments teach controlled rotation of the “fixed” element. The prior art discloses that free rotation of the control element prevents the transmission of torque from the input to the output of the planetary gear system.

Though any two elements of the planetary gear system can be used as input and output and the third as the control element, the operational principles are best demonstrated if the ring gear is designated as the input element, the planetary carrier as the output element, and the sun gear as the control element.

If the sun gear (control element) is allowed to rotate freely, the output planetary carrier does not move regardless of the rotational speed of the input ring gear. This scenario is referred to as a “zero” rotational output or a neutral state or neutral output. Alternatively, if the control sun gear is fixed, the planetary carrier rotates at a maximum rotational speed calculated from the input rotational speed of the ring gear and the gear ratios between the input (ring gear) and output (planetary carrier) elements. This ratio is defined as “unity” rotational output. Thus any gear ratio or output between “zero” and “unity” can be implemented by controlling rotation of the sun gear control element, with all other rotational speeds designated as a fraction of “unity.”

When the freely rotating sun gear is controlled to rotate faster than required to achieve a zero rotational output (“overdriven”), the output planetary carrier reverses its direction of rotation (precesses). Certain presented embodiments utilize an electromagnetic clutch or similar clutch mechanism to overdrive the control sun gear to achieve this reverse gear. This concept is critical and non-obvious over the prior art.

Thus, as described, there are three operational states when the sun gear is designated as the control gear: free rotation of the sun gear, retarded rotation of the sun gear (i.e., a rotational speed less than the free rotational speed of the sun gear) and accelerated rotation of the sun gear (i.e., a rotational speed greater than the free rotational speed of the sun gear). These three operational states of the planetary gear system correspond respectively to the conventional automotive transmission states of neutral, forward, and reverse.

In its various embodiments, the present invention offers the following advantages over the prior art transmission systems. The invention provides a CVT that is not friction-based and works on the principal of geared wheels. The CVT gears are adapted to efficiently transmit force and torque without subjecting the elements to forces that can cause excessive wear, friction or breakage. When the ring gear input element receives rotational force from a motor or engine, these three transmission states can be achieved without requiring an energy-consuming torque converter or a standard clutch to disengage the transmission from the power source to shift gears. The planetary gear system of the present invention can replace conventional manual and automatic transmissions in motive vehicles.

Certain embodiments are useful in motive vehicles that do not require a “reverse” gear, such as, but not limited to, bicycles, motor scooters, mopeds, and some motorcycles. Other embodiments provide a “reverse” gear; these embodiments are useful for, but are not limited to, automobiles, trucks, tractors, some motorcycles, forklifts, ATVs, off road vehicles, and other such industrial applications where transmission of rotational motion requires variable gear ratios between input and output elements, in addition to a “reverse” gear.

Thus the various embodiments of the present invention provide a novel and unique CVT that unlike previous attempts can be implemented in a reliable, elegantly simple, and inexpensive manner. All the benefits typically attributable to a CVT are provided in the present invention, avoiding the shortcomings, limitations, and failures of other implementations.

Central to the present CVT implementation using a planetary gear system is the notion that if none of the elements is “fixed,” torque is not transmitted from input to output through the planetary gear system. But if rotation of the control element is controlled, a CVT with both forward and reverse gears is provided as further described below.

### Non-Reversing Embodiment

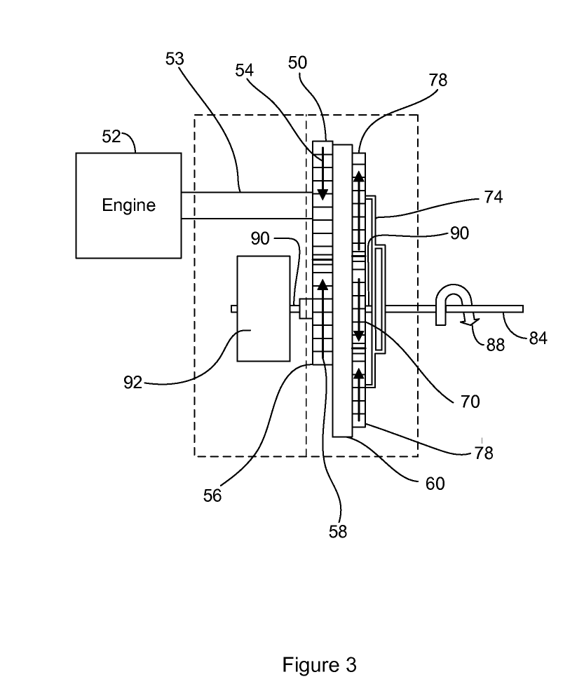

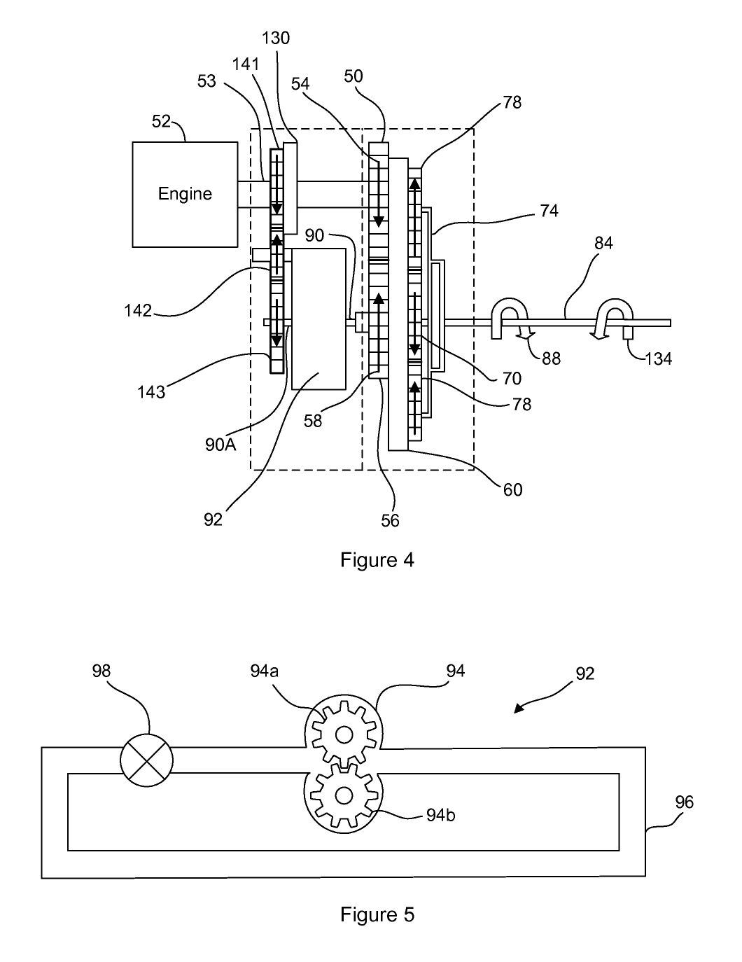

In one embodiment, the CVT of the present invention provides a gear system that acts as an efficient transmission and can replace conventional manual and automatic transmissions in motive vehicles that do not require a “reverse” gear, such as, but not limited to, bicycles, motor scooters, mopeds, and some motorcycles. This embodiment is illustrated in FIG. 3 and its control module is illustrated in FIG. 5.

In the FIG. 3 embodiment, a sun gear 70 operates as the control element, a ring gear 60 operates as the input (driven) element, and a planetary carrier 74 operates as the output element. As discussed above, if the control element sun gear 70 is allowed to freely rotate (is not fixed and its rotation is not controlled) no torque is transmitted and the planetary carrier 74 does not rotate (no output). If rotation of the control sun gear 70 is controlled, rotation of a planetary carrier output shaft 84 can be controlled.

A driven gear 50 (not an element of the planetary gear system) is driven by an engine 52 (or a motor, a diesel engine, a gasoline engine or another device for supplying a rotational force) through a shaft 53. The driven gear 50 turning in a first direction as indicated by an arrowhead 54 meshes with a back plate gear 56 turning in a second direction as indicated by an arrowhead 58. The oppositely-directed arrowheads 54 and 58 depict opposite rotational directions for the driven gear 50 and the back plate gear 56.

The back plate gear 56 and the ring gear 60 are affixed on the same shaft. In one embodiment the ring gear 60 and the back-plate gear 56 are machined as a single unit and mounted on the same shaft. Thus as the back-plate gear 56 is driven by the driven gear 50, the ring gear 60 also turns in the direction indicated by the arrowhead 58.

The sun gear 70 is fixed to a shaft 90 that supports separate mounting bearings for the ring gear 60 and the planetary carrier 74, permitting both the planetary carrier 74 and the ring gear 60 to freely rotate about the sun gear shaft. That is, both the planetary carrier 74 and the ring gear 60 are mounted on bearings coincident with the shaft 90; neither is affixed to the shaft 90. Thus the carrier 74 freely rotates about the sun gear shaft 90. Similarly the ring gear 60 freely rotates relative to the sun gear shaft 90.

As illustrated, the planetary gears 78 are mounted within the ring gear 60 to engage both interior-facing teeth of the ring gear 60 and outwardly-facing teeth of the sun gear 70. As the planetary gears 78 rotate, they remain in contact simultaneously with both the inwardly-facing teeth of the ring gear 60 and the outwardly-facing teeth of the sun gear 70.

The planetary carrier 74 is also attached to the output shaft 84 that reflects any rotation of the planetary carrier 74. An arrowhead 88 indicates a direction of rotation of the output shaft 84.

If the sun gear 70 rotates freely as the ring gear 60 is driven, the planetary gears 78 rotate on their individual shafts and will not precess around the ring gear 60 because the sun gear 70 can move. Thus the planetary carrier 74 and the output shaft 84 do not rotate. But if the sun gear 70 is fixed or its rotation is retarded, the planetary gears 78 precess around the ring gear 60 and therefore move the planetary carrier 74.

The sun gear shaft 90 is attached through an appropriate gear set, to a shaft of a hydraulic pump, one component of a possible CVT control module 92, which is illustrated in greater detail in FIG. 5.

With reference to FIG. 5, a hydraulic pump 94 is attached to a high-pressure hydraulic loop 96 containing a mechanically, electrically, electromechanically, or hydraulically controlled control valve 98. The control valve 98 regulates the volume of hydraulic fluid in the loop 96 and therefore the volume passing through the hydraulic pump 94

The sun gear shaft 90 (see FIG. 3) is attached to a shaft of one of the two hydraulic pump gears 94A and 94B and thus rotation of the sun gear shaft 90 and its attached sun gear 70 is controlled by the pump 94, which is in turn controlled by the flow of fluid in the loop 96, which is in turn controlled by operation of the valve 98.

The size, volume, and pressure of the hydraulic loop 96 are chosen to match the horsepower of the CVT power source, e.g., the engine 52. Because the hydraulic pump 94 acts as a brake, the pump must be capable of producing a braking force sufficient to stop the sun gear 70, i.e., overcome the horsepower of the engine 52. In other embodiments the hydraulic pump/control module can be replaced by any device capable of controllably braking the control element. The brake is mechanically, electrically or hydraulically controlled to provide the required braking forces.

When the control valve 98 is fully open, the hydraulic pump 94 freely pumps the hydraulic fluid around the loop, thus permitting the attached sun gear shaft 90 and its associated sun gear 70 to freely rotate. In this configuration the CVT achieves a “geared neutral” state. The engine 52 turns the input ring gear 60; the ring gear 60 turns the planetary gears 78. But the planetary carrier 74 as connected to the CVT output shaft 84 does not turn. Recall that torque cannot be transmitted from an input to an output if all three gears of the planetary gear system can freely rotate.

As the control valve 98 is closed, the speed of the hydraulic pump 94 and consequently the speed of the attached sun gear 70 falls. This causes the planetary carrier 74 to rotate in the direction indicated by the arrowheads 88 in FIG. 3. The slower the sun gear 70 rotates, the faster the planetary carrier 74 rotates. When the control valve is fully closed, the pump 94 and the attached sun gear 70 cease turning. In this configuration the CVT achieves its maximum gear ratio (high gear). Note that operation of the present invention contradicts the premise that to transfer torque with a planetary gear system one of the gears must remain fixed. In fact, the present invention causes rotation of the output shaft when rotation of one of the gears is controlled.

When the sun gear 70 is fixed, as controlled by the CVT control module 92, the planetary carrier 74 rotates in the direction indicated by the arrowhead 88 at a speed calculated by gear ratio rules applicable to standard planetary gear systems:

Ratio=(R teeth+S teeth)/R teeth,

where (R teeth) is the number of gear teeth in the ring gear, and
(S teeth) is the number of gear teeth in the sun gear.

This fixed sun gear condition is referred to as the “unity” ratio and the condition where the sun gear rotates freely is referred to as the “zero” ratio. The “unity” ratio is the highest gear ratio possible within the CVT system and the rotation speed is determined by arrangement of input and output gears external to the CVT planetary gear system.

In yet another embodiment of the subject invention, the sun gear 70 is the input or the output element, the planetary carrier 74 is the other of the input or output element, and the ring gear 60 is the control element. In this embodiment the CVT control module 92 is attached to the ring gear 60.

In yet another embodiment of the subject invention, the sun gear 70 is the input or the output element, the ring gear 60 is the other of the input or output element, and the planetary carrier 74 is the control element. In this embodiment the CVT control module 92 is attached to the planetary carrier.

Implementation of any CVT design based on the present invention need determine only the maximum output rotational speed required and select external gear sets to achieve that speed when the CVT control gear is fixed. All other CVT output gear ratios between “zero” and “unity” are determined by slowing the control gear rotational speed to some fractional value of the freely rotating control gear rotational speed.

### Reversing Embodiment

Another embodiment (illustrated in FIG. 4) of the CVT of the present invention teaches an efficient transmission that can replace conventional manual and automatic transmissions in motive vehicles requiring a “reverse” gear, such as but not limited to, automobiles, trucks, tractors, some motorcycles, forklifts, ATVs, off-road vehicles, lawn mowers and other such industrial applications where transmission of rotational motion further requires variable gear ratios and at least one reverse gear ratio between the input and output elements.

FIG. 4 depicts a preferred mechanical configuration of the present invention in a CVT configuration with a “reverse” gear capability and wherein the sun gear 70 is chosen as the control element, the ring gear 60 as the input element and the planetary carrier 74 as the output element. As with the non-reversing embodiments, other choices of input, output, and control elements create a useful CVT.

The engine 52 (or motor) provides rotational movement through the input ring gear 60. If the control sun gear 70 is allowed to freely rotate (is not fixed and its rotation not impeded or accelerated) no torque is transmitted and the planetary carrier 74 does not rotate. As a result there is no rotation of the output shaft 84. However, if the sun gear 70 is fixed, the planetary carrier 74 rotates at a rate calculable by the gear ratio rules applicable to standard planetary gear systems:

Ratio:=(R teeth+S teeth)/R teeth; (output/input ratio)

where (R teeth) is the number of gear teeth in the ring gear and

(S teeth) is the number of gear teeth in the sun gear.

The condition where the sun gear is fixed is referred to as the “unity” ratio and the condition where the sun gear freely rotates is referred to as the “zero” ratio. The “unity” ratio provides the highest gear ratio possible with the CVT and its value is determined by the arrangement of input and output gears external to the CVT planetary gear system.

As in the non-reversing embodiment, to implement a CVT based on the present invention, it is necessary to determine only the maximum output rotational speed required and select external gear sets to achieve that speed when the CVT sun gear 70 is fixed. All other CVT output gear ratios between “zero” and “unity” are determined by slowing the sun gear rotational speed to some fractional value of a freely rotating sun gear. Any sun gear rotational speed greater than “zero” state (freely rotating) causes the planetary carrier 74 and the output shaft 84 to rotate in the reverse direction.

With reference to FIG. 4, the sun gear 70 is attached to the shaft 90 that supports separate mounting bearings for the ring gear 60 and the planetary carrier 74. This arrangement permits both the planetary carrier 74 and ring gear 60 to freely rotate about the sun gear shaft 90. The sun gear 70 meshes with the planetary gears 78 that in turn mesh with the ring gear 60.

The ring gear 60 is driven by a combination of the driven gear 50 (driven by the engine 52) and the back-plate gear 56. The ring gear 60 turns in the direction of the arrowhead 58.

In FIG. 4, the sun gear shaft 90 is attached to the CVT control module 92. As in the non-reversing embodiment, when the valve 98 (see FIG. 5) is fully open, the hydraulic pump 94 freely pumps the hydraulic fluid around the loop 96 thus permitting the attached sun gear 70 to freely rotate and causing the CVT to achieve a “geared neutral” state. As the control valve 98 is closed, the speed of the hydraulic pump 94 and consequently the attached sun gear 70 are slowed, causing the output shaft 84 to accelerate and to rotate in the direction indicated by the arrowhead 88 in FIG. 4. Thus in this reversing embodiment too, there exists an inverse relationship between rotation of the sun gear 70 and rotation of the planetary carrier 74. The slower the sun gear rotates the faster the planetary carrier rotates. When the control valve is closed, the pump and sun gear cease turning and the CVT achieves its maximum gear ratio (high gear).

When a “reverse” gear is selected, the control valve 98 (FIG. 5) is fully opened to achieve the “zero” or “neutral” state of the CVT and a clutch 130 is engaged to overdrive the pump 94 that in turn overdrives the sun gear shaft 90. With the clutch 130 engaged, rotational torque from the engine 52 is transferred to a shaft extension 90A (an extension of the shaft 90 of the control module 92) via gears 141, 142 and 143. This accelerates the pump 94, causing the attached sun gear 70 to accelerate beyond the rotational speed of the sun gear 70 in the “neutral” state. This condition causes the planetary carrier 78 to precess backwards and the attached output shaft 84 to rotate in a reverse direction, as indicated by an arrowhead 134 in FIG. 4.

The clutch 130 is used to overdrive the control module/pump/sun gear to achieve reverse. The clutch 130 can therefore be a relatively small device as when in reverse gear the vehicle does not usually require full horsepower or high speed.

When the CVT is shifted into forward or neutral the clutch 130 is disengaged. This elegantly simple control procedure provides a CVT with capabilities equivalent to a standard automatic transmission in today's automobiles.

Note that in the “reverse gear” embodiment of FIG. 5, the control module 92 does not require a clutch or a second hydraulic pump.

In yet another embodiment of the subject invention, the sun gear 70 could be used as the input element and the ring gear 60 as the control element. In this case the control module 92 is attached to the ring gear shaft through appropriate gearing to achieve a similarly functioning CVT, as is understood by those skilled in the art.

In still another embodiment of the subject invention, the sun gear 70 serves as the input element and the planetary carrier 74 as the control element. In this case the control module 92 is attached to the planetary carrier 74 through appropriate gearing to achieve a similarly functioning CVT, as is understood by those skilled in the art.

Although the presented embodiments have been shown and described with respect to a certain preferred embodiments, it is obvious that equivalent alterations and modifications will occur to others skilled in the art upon the reading and understanding this specification and the annexed drawing. In particular regard to the various functions performed by the above described components (assemblies, devices, circuits, etc.), the terms used to describe such components are intended to correspond, unless otherwise indicated, to any component that performs the specified function of the described component (i.e., that is functionally equivalent), even though not structurally equivalent to the disclosed structure that performs the function in the described embodiment. In addition, while a particular feature of the invention may have been disclosed with respect to only one of several embodiments, such feature may be combined with one or more other features of the other embodiments as may be desired and advantageous for any given or particular application.

What is claimed is:

1. A continuously variable transmission responsive to a device for supplying a rotational force, the transmission comprising:
a planetary gear system further comprising:
a control element;
an output element; and
an input element caused to rotate responsive to the device for supplying rotational force;
wherein the output element is engaged with the control element and the input element; and
a control module comprising a controllable brake connected to the control element for allowing the control element to rotate freely, for stopping the control element and for slowing the control element to a speed between free rotation and stopped.

2. The continuously variable transmission as claimed in claim 1 wherein the control element comprises a sun gear, the input element comprises one of a ring gear and a planetary carrier and the output element comprises an other of the ring gear and the planetary carrier.

3. The continuously variable transmission as claimed in claim 1 wherein the control element comprises a ring gear, the input element comprises one of a sun gear and a planetary carrier and the output element comprises an other of the sun gear and the planetary carrier.

4. The continuously variable transmission as claimed in claim 1 wherein the control element comprises a planetary carrier, the input element comprises one of a sun gear and a ring gear and the output element comprises an other of the sun gear and the ring gear.

5. The continuously variable transmission as claimed in claim 1 the controllable brake controlled mechanically, electrically or hydraulically.

6. The continuously variable transmission as claimed in claim 1 wherein the control module comprises a closed hydraulic loop for circulating hydraulic fluid, wherein a controllable hydraulic valve and a hydraulic pump are connected in the hydraulic loop, and wherein the hydraulic valve is controlled to slow or stop the control element, and wherein operation of the output element is responsive to operation of the control element.

7. The continuously variable transmission as claimed in claim 1 wherein when the control element rotates freely the output element does not rotate, and wherein when the control element stops rotating the output element attains maximum speed.

8. The continuously variable transmission as claimed in claim 1 wherein the control module controls the control element to a speed between free rotation and stopped to control rotation of the output element to a desired speed.

9. The continuously variable transmission as claimed in claim 1 wherein a first shaft carrying the control element is connected to a second shaft of the control module, wherein rotation of the second shaft is controlled by the control module.

10. The continuously variable transmission as claimed in claim 1 wherein a number of teeth in each of the control element, the output element and the input element are selected to achieve a desired maximum output rotational speed.

11. The continuously variable transmission as claimed in claim 1 wherein the control module controls the control element to an overdrive condition, wherein in the overdrive condition the control element rotates faster than when rotating freely and wherein in response thereto the output element precesses in a reverse direction.

12. The continuously variable transmission as claimed in claim 11 further comprising a shaft having one end connected to the device for supplying the rotational force through a clutch, and having a second end connected to the control module, the clutch engaged to control the control element to the overdrive condition responsive to the device for supplying the rotational force.

13. The continuously variable transmission as claimed in claim 1 wherein the control element comprises a sun gear, the input element comprises a ring gear and the output element comprises the planetary carrier driving an output shaft, and wherein the control module controls rotation of the sun gear, when the control module controls the sun gear to rotate freely the output shaft does not rotate, when the control module controls the sun gear to not rotate the output shaft attains a maximum rotational speed, and as the control module decreases the rotational speed of the sun gear the rotational speed of the output shaft increases, and as the control module controls the sun gear to rotate at a rate greater than a free rotation speed, the planetary carrier and the output shaft reverse direction.

14. The continuously variable transmission as claimed in claim 13 wherein the control module comprises a brake and a closed hydraulic loop for circulating hydraulic fluid, wherein a controllable hydraulic valve and a hydraulic pump are connected in the hydraulic loop, and wherein the hydraulic valve is controlled to one of an open condition, a closed condition and a condition between the open condition and the closed condition to control rotation of the sun gear.

15. The continuously variable transmission as claimed in claim 1 wherein the device for providing rotational force comprises an electric motor, a gasoline engine or a diesel engine.

16. The continuously variable transmission as claimed in claim 1 further comprising one or more gears interposed between the device for providing rotation force and the input element.

17. The continuously variable transmission as claimed in claim 1 having a neutral, forward and reverse state responsive to operation of the control element.

18. A method for providing a neutral, forward and reverse operating state for a continuously variable transmission, the transmission comprising a planetary gear system further comprising a control element, an output element, and an input element caused to rotate responsive to a device for supplying rotational force, wherein the output element is engaged with the control element and the input element, the method comprising:
controlling the control element
to rotate freely causing the output element to attain a stopped condition;
to stop causing the output element to attain a maximum forward operating speed;
to slow causing the output element to attain a speed between the stopped condition and the maximum forward speed; and
to attain an overdrive condition, wherein in the overdrive condition the control element rotates faster than when rotating freely, and wherein in response thereto the output element precesses in a reverse direction.

19. The method of claim 18 wherein the control element comprises a sun gear, the input element comprises a ring gear and the output element comprises a planetary carrier.

20. The method of claim 18 further comprising an electrical, mechanical or hydraulic brake for controlling the control element.
